(19) United States
(12) Patent Application Publication
(10) Pub. No.: US 2022/0390618 A1
(43) Pub. Date: Dec. 8, 2022

(54) ATTITUDE DETERMINATION USING A GNSS RECEIVER

(71) Applicant: Tupaia Ltd., Ramat-Hasharon (IL)

(72) Inventors: Nadav Lavi, Ramat-Hasharon (IL); Gad Zalcberg, Karney Shomron (IL); Yuval Chipman, Givatayim (IL); Kobi Scheim, Pardess-Hanna (IL)

(73) Assignee: Tupaia Ltd., Ramat-Hasharon (IL)

(21) Appl. No.: 17/804,729

(22) Filed: May 31, 2022

Related U.S. Application Data
(60) Provisional application No. 63/196,388, filed on Jun. 3, 2021.

(51) Int. Cl. G01S 19/41; G01S 19/53; G01S 19/30; G01S 19/44

(52) U.S. Cl. CPC G01S 19/41; G01S 19/53; G01S 19/30; G01S 19/44

(57) ABSTRACT

A system and method for determining attitude of an end point equipment (EPE) using a global navigation satellite system (GNSS) receiver. The method includes collecting signals and radio frequency (RF) switch states, wherein the signals are GNSS signals received by at least one GNSS antenna of an end point equipment (EPE), wherein the signals are associated with the respective RF switch states; generating differencing data of the signals with respect to reference measurements, wherein the reference measurements are collected from a GNSS receiver at a reference station in a predetermined distance from the EPE; determining an attitude of the EPE based on the generated differencing data; and causing reorientation of the EPE based on the determined attitude.

### CROSS-REFERENCE TO RELATED APPLICATIONS

This application claims the benefit of U.S. Provisional Application No. 63/196,388 filed on Jun. 3, 2021, the contents of which are hereby incorporated by reference.

### TECHNICAL FIELD

The present disclosure relates generally to satellite systems, more particularly to attitude determination systems in satellite communication.

### BACKGROUND

Global navigation satellite systems (GNSS) including the global positioning system (GPS) of the U.S., BeiDou of China, Galileo of the European Space Agency, and GLONASS of Russia are positioning technologies that use signals from satellites to provide accurate information about a user's positional information (e.g., location, speed, direction of travel, and more). Such satellite systems include multiple satellites with each broadcasting signals to a receiver unit on earth.

The receiver unit, or an end point equipment (EPE), includes at least one antenna and a corresponding end point receiver (EPR), which is mounted on a target platform at a user location to receive radio signals from the satellites and/or ground stations. Such signals may be processed by the receiver for parameters such as position, velocity, time, or attitude, which defines the orientation of the target platform. To this end, the EPE is utilized for effective GNSS-based attitude determination of target platforms in many fields including aviation, marine, agriculture, broadband Internet, and more.

FIG. 1 shows an example diagram of a conventional system for GNSS-based attitude determination 100. A conventional design includes at least three GNSS antennas 110-1 through 110-N (hereinafter referred individually as a GNSS antenna 110 and collectively as GNSS antennas 110; and wherein N is an integer equal or greater than 3) mounted on a rigid target platform with each GNSS antenna 110 connected to an end point receiver (EPR) 120. A plurality of antennas 110-1 to 110-N are each connected to respective EPR 120-1 through 120-N (hereinafter referred individually as an EPR 120 and collectively as EPRs 120; and wherein N is an integer equal or greater than 3). Individual GNSS antenna 110 and corresponding EPR 120, together form an end point equipment (EPE) 130-1 through 130-N (hereinafter referred individually as an EPE 130 and collectively as EPEs 130; and wherein N is an integer equal or greater than 3) that is capable of receiving and processing signals from the satellites 150 that are at line-of-sight (LoS). Each EPR 120 individually include an analog front end, digital baseband, and a processor; and are all connected to a central processing receiver 140 located locally or remotely. The central processing receiver 140 collects the measurements from multiple EPEs 130 to search, detect, track, and perform calculations such as phase range differences of multiple GNSS satellites 150 concurrently. The differenced carrier phase range is taken between few or all of the connected GNSS antennas 110, which is taken with the prior known baseline to estimate the attitude of the target platform. It has been identified that the above-mentioned configuration is rather complex and costly due to use of multiple analog front ends that need to be carefully designed and tuned. Furthermore, the EPR 120 needs to be uniquely designed according to the specific application of the GNSS-based attitude determination system.

An example application for GNSS-based attitude determination is in the field of satellite communication (SatCom). The EPE for SatCom is configured with a satellite dish including either an antenna array with beam forming capability or an antenna with mechanical steering and a EPR to communicate with at least one, normally multiple, communication satellites. Communication satellites for such application are typically Low Earth Orbit (LEO) or Medium Earth Orbit (MEO) satellites that orbit at high angular speed and therefore the visibility time for each satellite is in the order of few minutes. To this end, ground-based EPE must be configured to effectively communicate with multiple satellites, potentially simultaneously, for optimized and undisrupted communication link. It is particularly challenging for attitude determination by the EPE since measurements must be collected from plurality of satellites passing by at very high speed.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining attitude of an end point equipment (EPE) using a global navigation satellite system (GNSS) receiver. The method comprises: collecting signals and radio frequency (RF) switch states, wherein the signals are GNSS signals received by at least one GNSS antenna of an end point equipment (EPE), wherein the signals are associated with the respective RF switch states; generating differencing data of the signals with respect to reference measurements, wherein the reference measurements are collected from a GNSS receiver at a reference station in a predetermined distance from the EPE; determining an attitude of the EPE based on the generated differencing data; and causing reorientation of the EPE based on the determined attitude.

Certain embodiments disclosed herein also include a non-transitory computer readable medium having stored thereon causing a processing circuitry to execute a process, the process comprising: collecting signals and radio frequency (RF) switch states, wherein the signals are GNSS signals received by at least one GNSS antenna of an end point equipment (EPE), wherein the signals are associated with the respective RF switch states; generating differencing data of the signals with respect to reference measurements, wherein the reference measurements are collected from a GNSS receiver at a reference station in a predetermined distance from the EPE; determining an attitude of the EPE based on the generated differencing data; and causing reorientation of the EPE based on the determined attitude.

Certain embodiments disclosed herein also include a system for determining attitude of an end point equipment (EPE) using a global navigation satellite system (GNSS) receiver. The system comprises: a processing circuitry; and a memory, the memory containing instructions that, when executed by the processing circuitry, configure the system to: collect signals and radio frequency (RF) switch states, wherein the signals are GNSS signals received by at least one GNSS antenna of an end point equipment (EPE), wherein the signals are associated with the respective RF switch states; generate differencing data of the signals with respect to reference measurements, wherein the reference measurements are collected from a GNSS receiver at a reference station in a predetermined distance from the EPE; determine an attitude of the EPE based on the generated differencing data; and cause reorientation of the EPE based on the determined attitude.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a conventional system for GNSS-based attitude determination according to an embodiment.

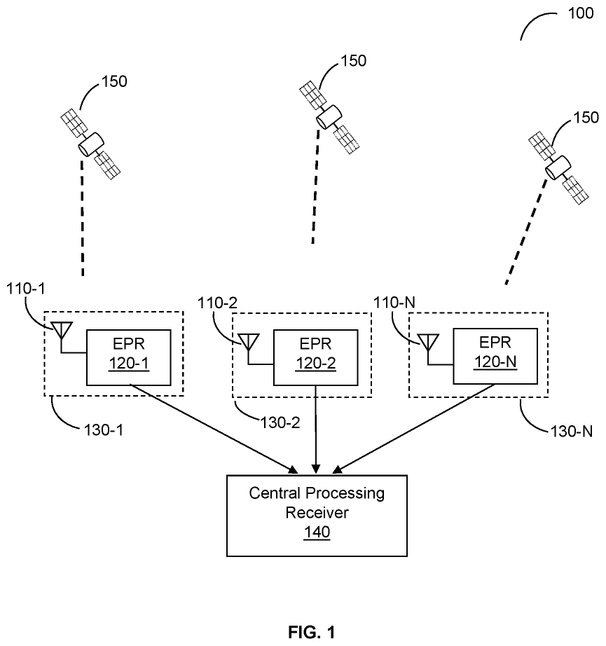

FIG. 2A is a network diagram utilized to describe the various disclosed embodiments.

FIG. 2B is a schematic diagram of an end point equipment (EPE) according to an embodiment.

FIG. 2C is an example schematic diagram of a satellite dish according to an embodiment.

FIG. 3 is a block diagram of a GNSS-based attitude determination system according to an embodiment.

FIG. 4 is a flowchart illustrating the method for determining attitude of a satellite dish according to an embodiment.

FIG. 5 is a flowchart illustrating the method for improving satellite communication link from the EPE according to an embodiment.

FIG. 6 is a schematic diagram of an analysis server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for effectively determining attitude using at least one Global navigation satellite system (GNSS) receiver. To this end, the disclosed embodiments utilize at least one standard GNSS receiver to reduce complexity and cost of a system for GNSS-based attitude determination. In particular, a radio frequency (RF) switch and/or combiner and a controller is coupled together to one or more GNSS receiver within an end point receiver (EPR) to effectively manage the multiple input GNSS satellite signals. It has been determined that accurate attitude determination is difficult using fast orbiting communication satellites. To this end, the disclosed embodiment includes multiple GNSS antennas on the end point equipment (EPE) on the same platform as the communication antennas, which are utilized for attitude determination through signals from GNSS satellites. The disclosed embodiments further provide improved satellite tracking and selection techniques, which, in combination with accurate attitude determination, provide more reliable and increased GNSS and communication receptions. A satellite dish is described as a non-limiting example of a target platform; however, the target platform may be any platform that includes GNSS antennas for which attitude determination is desired, including various movable machinery.

In an embodiment, signals from medium earth orbit (MEO) satellites, and low earth orbit (LEO) satellites are received and processed to determine attitude of the EPE or any target platform. The MEO satellite are situated between the geostationary orbit (GEO) and the LEO between 5,000 and 12,000 km above the surface of the Earth and typically takes two to eight hours to complete one orbit around the Earth. GNSS satellites as an example are orbiting in altitudes of 20000-28000 km with typical two earth orbits per day. The closest orbiting satellite are the LEO satellites which orbit at about 200 to 2000 km above the Earth's surface. These LEO satellites tend to be smaller in size and orbits at high angular velocity to complete an orbit in about 100 minutes or less. The proximity of such satellites significantly decreases the latency of communication while increasing signal strength.

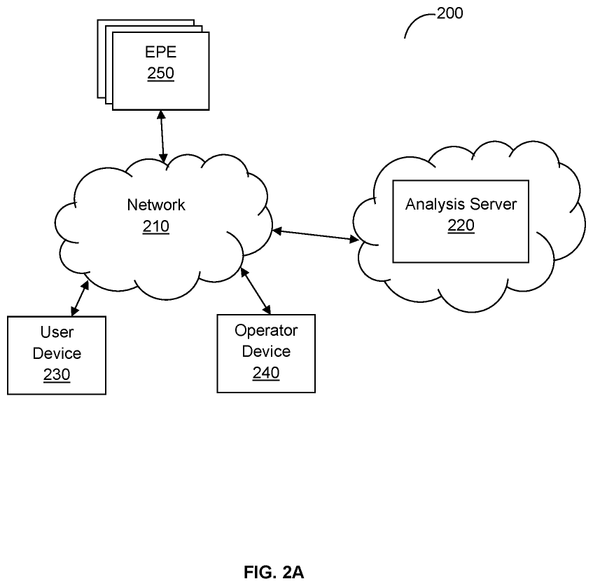

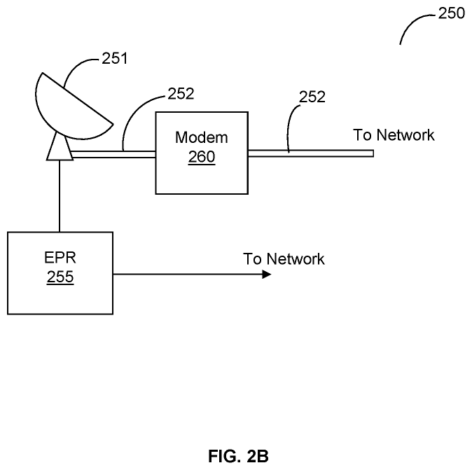

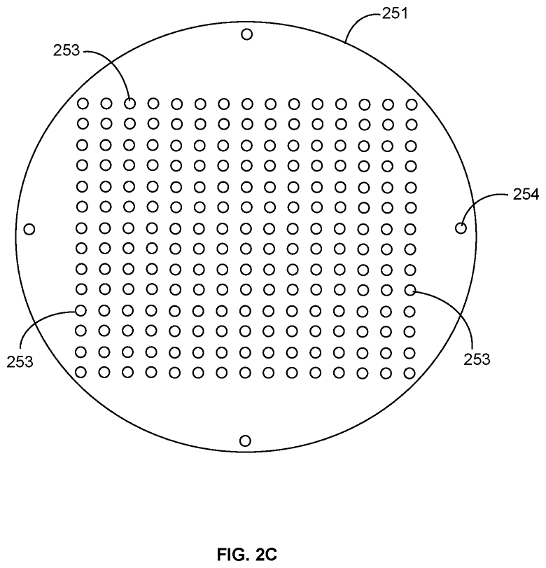

FIG. 2A shows an example network diagram 200 utilized to describe the various disclosed embodiments. In the example network diagram 200, a user device 230, an operator device 240, an EPE 250, and an analysis server 220 are communicatively connected via a network 210. The network 210 may be, but is not limited to, a wireless, cellular or wired network, a local area network (LAN), a wide area network (WAN), a metro area network (MAN), the Internet, the worldwide web (WWW), similar networks, and any combination thereof.

The user device 230 and the operator device 240 may be, but is not limited to, a personal computer, a laptop, a tablet computer, a smartphone, a wearable computing device, or any other device capable of receiving, processing and displaying notifications. These devices are configured to receive information and notification about EPE positional and attitude information determined by the analysis server 220.

The EPE 250 is a communications component configured to relay signals between a user and a plurality of GNSS and communications satellites. In an embodiment, these signals, and particularly from the communication satellites, may provide broadband Internet satellite communication. In an example embodiment, the closest orbiting LEO satellites are utilized for fast and low latency Internet satellite service. Due to their high angular velocity and short visibility time, a satellite internet constellation including a plurality of LEO satellites needs to be established for continuous service. Here, ground stations on Earth relay Internet satellite data to and from the plurality of satellites (connected individually or simultaneously), as well as to the EPEs 250 to provide such Internet satellite service to a user device 230, for example, at the user location.

According to disclosed embodiments, the EPE 250 is connected to the analysis server 220 over the network 210. The EPE 250 is configured to provide processed raw measurements of GNSS signals received by at least one GNSS antenna. Based on these raw measurements, the server 220 is configured to determine the attitude of the target platform or satellite dish of the EPE 250. The determined attitude information may be provided to the EPE 250 and/or satellite communication (SatCom) antenna controller (not shown) to guide reorientation of EPE, and thus improve communication link between the communication satellites and the user. Furthermore, the attitude information feedback may increase accuracy in attitude determination as well as satellite tracking and selection, again to enhance communication reception for the user. It should be noted that a plurality of EPEs 250 may be communicatively connected to the analysis server 220 to serve a plurality of users. The analysis server 220 may be configured locally or remotely such as, but not limited to, a cloud computing platform. The cloud computing platform may be a private cloud, a public cloud, a hybrid cloud, or any combination thereof.

FIG. 2B shows a schematic diagram of an EPE 250 according to an embodiment. As disclosed above, the EPE 250 is configured to receive radio frequency signals from the satellites at the user's premise for satellite communication. The EPE 250 may include a satellite dish 251 connected to a modem (or router) 260 via a cable 252, such as Ethernet radio-frequency coaxial or power cable. In an embodiment, Internet satellite communication signals received from the satellite dish 251 are transferred to the modem 260, providing Internet satellite service to the user through a network.

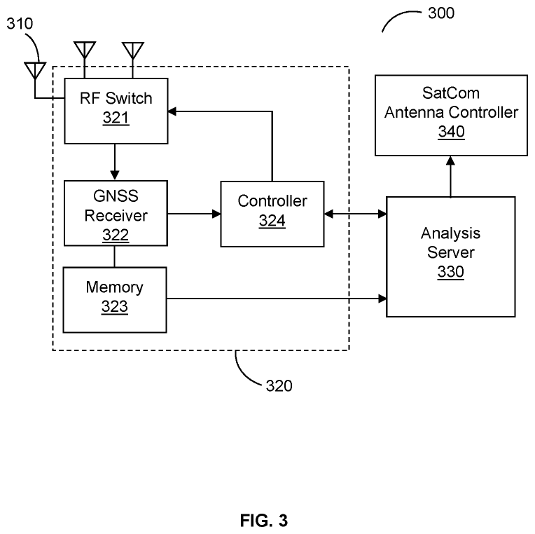

In an embodiment, the satellite dish 251 may include at least one of: a GNSS antenna, a communication antenna, a receiver, and a processor. In further embodiment, the EPE 250 may include an end point receiver (EPR) 255 for receiving and processing signals from a plurality of GNSS antennas. In an embodiment, the EPR 255 is configured to include an RF switch and/or combiner as well as a controller (not shown). As discussed further below in FIG. 3, these components are realized in order to effectively utilize the plurality of GNSS signals for raw measurements such as, but not limited to, code phase, carrier phase, frequency doppler shift, carrier-to-noise ratio (CNR) per each received satellite, multipath indication, cycle slip indication, and the like. These raw measurements may be then transferred to the analysis server (220, FIG. 2A) over the network.

FIG. 2C is an example schematic diagram of a satellite dish 251 according to an embodiment. In an example embodiment, a single planar satellite dish 251 is configured with a plurality of GNSS antennas 254 and a plurality of satellite communication antennas 253 to communicate with both GNSS and communication satellites, respectively. The GNSS antennas 254 are tuned to the GNSS bands (e.g., single, dual, or more and L1, L2, L5 to list a few) for signal transfer. Here, in the example FIG. 2C, four GNSS satellite antennas 254 are shown to be located at the periphery of the satellite dish 251 at maximal distance between each other as a non-limiting example. In a typical configuration, at least three GNSS antennas are utilized.

In addition, the plurality of satellite communication antennas 253 may be configured in an array form that are coordinated and controlled to shape the entire antenna beam pattern. In an example embodiment, the satellite communication antennas 253 in the array are separated by half of a wavelength per dimension and configured to build-up a narrow beam pattern towards a designated direction (i.e., toward orbiting communication satellite). In an embodiment, the satellite dish 251 may be any planar target platform on an object in which an attitude determination is desired.

FIG. 3 is an example block diagram of the GNSS-based attitude determination system according to an embodiment. In the example block diagram 300, an RF switch 321, a GNSS receiver 322, a memory 323, and a controller 324 are components within the EPR 320. The EPR 320 may include one or more standard GNSS receivers 322 without departing the scope of the disclosed embodiments. The RF switch 321 directs the received signals from a single or a combination of few GNSS antennas 310 on the satellite dish to the GNSS receiver 322. These raw measurements may be stored at the memory 323 and/or collected by the controller 324, which are processed at the analysis server 330. The raw measurements may be, for example, per satellite code and phase measurements, pseudo-ranges, signal to noise ratio (SNR), frequency doppler, and the like. In an embodiment, the attitude of the satellite dish determined by the analysis server 330 are utilized at the SatCom antenna controller 340 to optimize the satellite dish orientation for high communication reception.

The RF switch 321 is configured to either select or combine antenna signals from the plurality of GNSS antennas 310 on the satellite dish. In this embodiment, the GNSS receiver 322 is unaware of the selecting or combing of antenna signals during the operation to receive a single set of processed signals. In further embodiments, the selecting or combining of signals may be realized at any of: radio frequency signal, intermediate frequency band (IF), and baseband frequency of the EPR 320. The GNSS receiver 322 may provide code phase or carrier phase measurements, which may be based on per satellite residual. The GNSS receiver 322 is also configured to decode the satellites ephemerides by decoding almanac and ephemeris data broadcasted by the GNSS satellites. The processing of the decoded information results in each satellite precise location in space and time. In an embodiment, the EPR 320 may exist on the satellite dish (i.e., embedded). In another embodiment, the EPR 320 may be located separately from the satellite dish.

In addition to collecting raw measurements, the controller 324 is configured to maintain a policy for directing the combining or selecting of GNSS antenna signals at the RF switch 321. The policy may include timing and order of the antenna switching, as well as combining parameters for GNSS antenna signal combining. In an embodiment, the policy may be determined according to the reported raw measurements and decoded satellite location information (i.e., almanac and ephemeris data) from the EPR 320. In another embodiment, the policy may be changed according to a GNSS antenna model, GNSS satellites constellation, and surroundings of the EPE (250, FIG. 2A) for best signal reception. In a further embodiment, the policy may reside in other locations, such as a remote server, for possibly more optimized measurements collected from multiple EPEs in the vicinity.

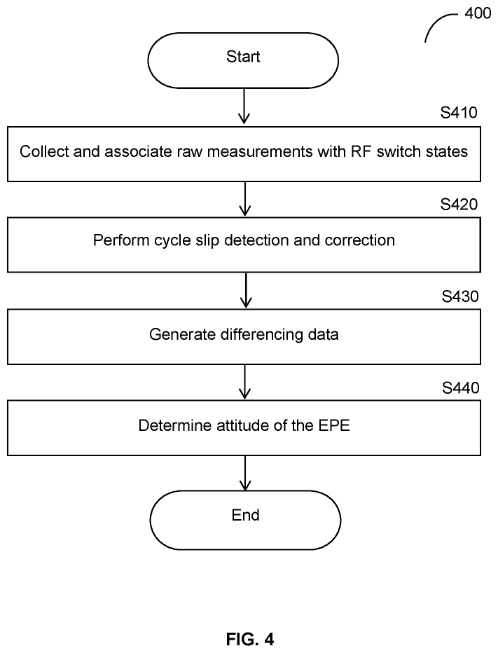

FIG. 4 is an example flowchart 400 illustrating the method for determining attitude of a satellite dish according to an embodiment. In an embodiment, the raw measurements are generated at the EPE 250 and the method is carried out at the analysis server 220, FIG. 2A.

At S410, measurements and RF switch states are collected from the EPR of the EPE. Such measurements (or signals) may be saved locally in the server (220, FIG. 2A). As noted above, the RF switch is configured to select or combine GNSS antenna signals according to the policy at the controller within the EPR. Raw measurements determined at the EPR in addition to the switch state may be collected at the analysis server through the network. In another embodiment, the raw measurements are associated with RF switch states for further analysis. Association may include time tagging or other technique using meta data addition. In an embodiment, the raw measurements, RF switch state, time stamp, and other tagging information may be obtained from the memory of the EPR.

At S420, a cycle slip detection and correction are performed. In an embodiment, the switching mechanism of the EPR may result in carrier phase cycle slips. To this end, a cycle slip detection and correction may be performed for further processing and differencing alignment. In an example embodiment, the cycle slip detection algorithm may be, but not limited to, Least-square Ambiguity Decorrelation Adjustment (Lambda), Modified Ambiguity Function Approach (MAFA), Multi-Frequency combination, Jerk-based estimation, and the like. Such cycle slip detection algorithms are discussed in the related art.

At S430, differencing data is generated. The cycle slip corrected carrier phase measurements of GNSS signals are utilized to generate the differencing data. The differencing of raw measurements is performed with respect to another receiver in the vicinity of the EPE, termed as reference station measurements. A reference station may reside in a control station or be a dedicated station deployed in the vicinity of the EPE. In another embodiment, an EPE may serve as a reference station to other EPEs in its vicinity. Differencing data may be generated by the example equations that follows below.

In an example embodiment, the carrier phase range Rᵢ denotes the measurement received from ith satellite (SVᵢ) and may be defined in accordance with equation (1):

Rᵢ=ρᵢ−Iᵢ+Tᵢ+ORBᵢ+Cᵢ^{sat}+C^{u}+MPᵢ+AMBᵢ+εᵢ (1)

In the above equation (1), ρᵢ is a true range between the EPR antenna and the ith satellite (SVᵢ) antenna, Iᵢ is an ionosphere delay, Tᵢ is a troposphere delay, ORBᵢ is a range error due to satellite orbit offset, Cᵢ^{sat} is a satellite clock offset multiplied by the speed of light, C^{u} is a receiver clock bias multiplied by the speed of light, MPᵢ is a range error induced by multipath and non-line of sight signal propagation, AMBᵢ is phase ambiguity uncertainty multiplied by the wave length which exists only in carrier phase measurement, and εᵢ is a phase tracking loop error residual that typically has a standard deviation in the order of millimeters. All the above-listed component units are meters.

In a further embodiment, a single differenced pseudo-range, ΔRᵢ, with respect to a measured satellite range R_{ref} may be determined in accordance with equation (2):

ΔRᵢ=Rᵢ−R_{ref}=Δρᵢ−ΔIᵢ+ΔTᵢ+ΔORBᵢ+ΔC^{sat}+ΔMPᵢ+ΔAMBᵢ+δᵢ (2)

In the above equation, Δx denotes “the single difference of x”, where x is any of the above-mentioned components; parameters and errors. The receiver clock bias, C^{u}, in equation (1) cancels out in equation (2) because the receiver clock bias is common to all satellites tracked by the receiver.

In a further embodiment, a double differencing, ∇ΔRᵢ, between two receivers is generated in accordance with equation (3), which can be rewritten in the form of equation (4) to emphasize the three elements in double differencing: double different multipath, double differenced ambiguity term, and tracking loop noise.

∇ΔRᵢ=R_{i,1}−R_{ref,1}−(R_{i,2}−R_{ref,2})=∇Δρᵢ+∇ΔMPᵢ+∇ΔAMBᵢ+ξᵢ (3)

∇ΔRᵢ−∇Δρᵢ=∇ΔMPᵢ+∇ΔAMBᵢ+ξᵢ (4)

In the above equation, ∇Δx denotes “the double differencing of x,” where x is any of the above-mentioned components, parameters, or errors. The two receivers each concurrently performs single differencing with respect to a predetermined reference satellite with a measured satellite range, R_{ref}, and is similar for both receivers. In the equation, R_{i,1} is the carrier phase range measurement received by the first receiver, indicated by the second subscript, “1”, from the ith satellite (SVᵢ) and likewise, R_{i,2} is the carrier phase range measurement received by the second receiver (“2” in second subscript) from the ith satellite (SVᵢ). Here, the atmospheric satellite related errors (i.e., above rooftop) such as ionosphere delay (Iᵢ), troposphere delay (Tᵢ), range error due to satellite orbit offset (ORBᵢ), satellite clock offset time (Cᵢ^{sat}), and receiver clock bias time (C^{u}), and the like, may be cancelled out because such errors are similar for receivers that are within few kilometers distance one from each other.

In an embodiment, differencing may be at least one of: (a) time differencing where two consecutive measurements are differenced, (b) differencing measurements with respect to a reference satellite, and (c) differencing measurements between two receivers. A combination of the above in different order may result in several variants of the operation with different performance characteristics.

At S440, the attitude of the EPE is determined. The differencing information may be utilized to determine the attitude of the EPE using an attitude determination algorithm. In an embodiment, raw measurements of multiple EPEs in the vicinity may be shared to determine EPE attitude in any one of: fully-joint, partially-joint, and individual arrangements. In an embodiment, attitude parameters such as the Euler angles (i.e., roll, pitch, yaw) and quaternions, which define orientation of the EPE (e.g., the platform, the satellite dish, and the like), may be collected by the EPE and/or analysis server over a longer period of time (e.g., a predetermined time period) for a larger data set. Such large data set may be utilized to model long-time range attitude pattern based on neural network or machine learning techniques to result in attitude parameters of a single user.

In an embodiment, the determined attitude of the EPE may be utilized to cause reorientation of the EPE. The EPE may be reoriented in whole or portions, for example, but not limited to, the platform or the satellite dish of the EPE. It should be appreciated that the reorientation of the EPE enables continuous and enhanced communications between the EPE and the plurality of orbiting satellites.

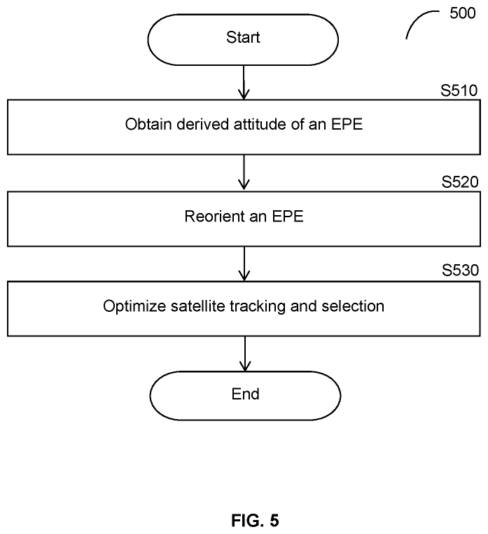

FIG. 5 is an example flowchart illustrating the method for improving satellite communication link from the EPE according to an embodiment. In an embodiment, the method is carried out at the SatCom antenna controller 340, FIG. 3.

At S510, an attitude of a EPE determined by the analysis server is obtained. The attitude information may be from the server over the network.

At S520, the EPE is reoriented for improved communication. The EPE orientation may be changed by setting a new boresight parameter according to obtained attitude information. In an embodiment, the parameter may be set locally at the EPE. In another embodiment, the parameter may be set remotely using a cloud computing or other remote server. In an embodiment, the EPE including the satellite communication antenna array may be configured with mechanical steering by an electric motor. In this scenario, attitude information is fed to the SatCom antenna controller for mechanical change of the EPE to face the direction of communication satellites.

At S530, tracking and selecting of the communication satellite may be optimized. The communication satellites orbit at high velocity, and thus proper tracking and selection of the communication satellite to receive signals directly affect communication effectiveness. The EPE orientation and reorientation information together with satellite positional information will increase communication link and reception for the user.

In another embodiment, a separate reference station on a remote site may be configured for a simpler RF switch/combiner hardware and improved EPR performances (e.g., signal-to-noise ratio (SNR), stabilization time, phase continuity, and the like, and any combination thereof), but for less real time results. The precise location of the reference station is not required because errors from inaccurate location can be easily removed. The EPE attitude is determined using carrier phase measurements generated at a single standard GNSS receiver in the EPE as described in the above disclosed embodiments.

In an example embodiment, the EPE at the user location is employed with a single GNSS receiver and four GNSS antennas. Further, the separate reference station exists on a remote site with a medium baseline. In such scenario, the rate of multiplexing (e.g., TR=10 to 30 seconds) between the GNSS antennas is slow with a short guard time (e.g., TG=10 milliseconds) between antennas, enabling relative position (RLP) determination of the active GNSS antenna to the reference station. The EPE may continuously communicate measurements to a relative positioning (RLP) engine in the server (220, FIG. 2A) with known GNSS antenna switching scheme and timing. The RLP engine resolves ambiguity in synchronism to known switch time resulting N number of RLP after a period of time, N*(TR+TG) (where N is the number of GNSS antennas on the EPE and is an integer equal to or greater than 3), relative to the same reference station. In an embodiment, the reference station may be a high-end type GNSS receiver and GNSS antenna located at a controlled site.

In another embodiment, the reference station may be another GNSS receiver connected to a single GNSS antenna. In this end, a particular user EPE may be configured to be in either reference mode, without antenna switching, or attitude determination mode, with antenna switching at known sequence. The RLP may collect raw measurements from both receivers to determine position and attitude of the targeted EPE.

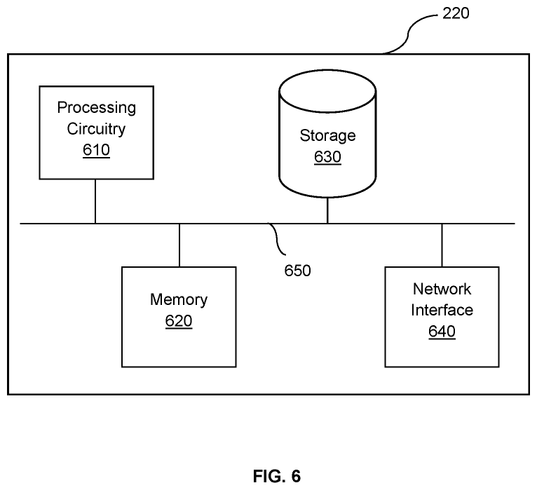

FIG. 6 is an example schematic diagram of an analysis server 220 according to an embodiment. The analysis server 220 includes a processing circuitry 610 coupled to a memory 620, a storage 630, and a network interface 640. In an embodiment, the components of the analysis server 220 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the analysis server 220 to communicate with, for example, the network 210.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining attitude of an end point equipment (EPE) using a global navigation satellite system (GNSS) receiver, comprising:
collecting signals and radio frequency (RF) switch states, wherein the signals are GNSS signals received by at least one GNSS antenna of an end point equipment (EPE), wherein the signals are associated with the respective RF switch states;
generating differencing data of the signals with respect to reference measurements, wherein the reference measurements are collected from a GNSS receiver at a reference station in a predetermined distance from the EPE;
determining an attitude of the EPE based on the generated differencing data; and
causing reorientation of the EPE based on the determined attitude.

2. The method of claim 1, further comprising:
performing a cycle slip detection and correction on the collected signals.

3. The method of claim 1, wherein causing reorientation of the EPE further comprises:
setting a new boresight parameter.

4. The method of claim 1, wherein the collected signals include any one of:
individually selected GNSS signals and combined GNSS signals.

5. The method of claim 1, further comprising:
collecting the signals and the RF switch states of a plurality of EPEs in a predetermined distance from one another; and
determining the attitude of the EPE based on at least a portion of the collected signals of the plurality of EPEs.

6. The method of claim 1, further comprising:
collecting a plurality of attitude parameters of the determined attitudes of the EPE for a predetermined time period; and
creating a long-time range attitude pattern from the plurality of attitude parameters for the EPE using a machine learning algorithm.

7. The method of claim 1, wherein the reference station is any one of: a control station, a dedicated station, and a second EPE.

8. The method of claim 1, wherein the signals include at least one of: code phase, carrier phase, frequency doppler shift, carrier-to-noise ratio (CNR) per each received satellite, ranges, multipath indications, and cycle slip indications.

9. The method of claim 1, wherein the EPE includes one GNSS receiver.

10. The method of claim 2, wherein the cycle slip detection is based on any one of: Least-square Ambiguity Decorrelation Adjustment (Lambda), Modified Ambiguity Function Approach (MAFA), Multi-Frequency combination, and Jerk-based estimation.

11. A non-transitory computer readable medium having stored thereon instructions for causing a processing circuitry to execute a process, the process comprising:
collecting signals and radio frequency (RF) switch states, wherein the signals are GNSS signals received by at least one GNSS antenna of an end point equipment (EPE), wherein the signals are associated with the respective RF switch states;
generating differencing data of the signals with respect to reference measurements, wherein the reference measurements are collected from a GNSS receiver at a reference station in a predetermined distance from the EPE;
determining an attitude of the EPE based on the generated differencing data; and
causing reorientation of the EPE based on the determined attitude.

12. A system for determining attitude of an end point equipment (EPE) using a global navigation satellite system (GNSS) receiver, comprising:
a processing circuitry; and
a memory, the memory containing instructions that, when executed by the processing circuitry, configure the system to:
collect signals and radio frequency (RF) switch states, wherein the signals are GNSS signals received by at least one GNSS antenna of an end point equipment (EPE), wherein the signals are associated with the respective RF switch states;
generate differencing data of the signals with respect to reference measurements, wherein the reference measurements are collected from a GNSS receiver at a reference station in a predetermined distance from the EPE;
determine an attitude of the EPE based on the generated differencing data; and
cause reorientation of the EPE based on the determined attitude.

13. The system of claim 12, wherein the system is deployed in a cloud computing platform.

14. The system of claim 12, wherein the system is further configured to:
perform a cycle slip detection and correction on the collected signals.

15. The system of claim 12, wherein the system is further configured to:
set a new boresight parameter.

16. The system of claim 12, wherein the collected signals include any one of:
individually selected GNSS signals and combined GNSS signals.

17. The system of claim 12, wherein the system is further configured to:
collect the signals and the RF switch states of a plurality of EPEs in a predetermined distance from one another; and
determine an attitude of the EPE based on at least a portion of the collected signals of the plurality of EPEs.

18. The system of claim 12, wherein the system is further configured to:
collect a plurality of attitude parameters of the determined attitudes of the EPE for a predetermined time period; and
create a long-time range attitude pattern from the plurality of attitude parameters for the EPE using a machine learning algorithm.

19. The system of claim 12, wherein the reference station is any one of: a control station, a dedicated station, and a second EPE.

20. The system of claim 12, wherein the signals include at least one of: code phase, carrier phase, frequency doppler shift, carrier-to-noise ratio (CNR) per each received satellite, ranges, multipath indications, and cycle slip indications.

21. The system of claim 12, wherein the EPE includes one GNSS receiver.

22. The system of claim 14, wherein the cycle slip detection is based on any one of: Least-square Ambiguity Decorrelation Adjustment (Lambda), Modified Ambiguity Function Approach (MAFA), Multi-Frequency combination, and Jerk-based estimation.
